(19) United States
(12) Patent Application Publication
(10) Pub. No.: US 2022/0086935 A1
(43) Pub. Date: Mar. 17, 2022

(54) METHOD AND APPARATUS FOR CONTROLLING RADIO RESOURCE FOR A REDUNDANT ROUTE FOR A DUAL-CONNECTING IAB-NODE IN A WIRELESS COMMUNICATION SYSTEM

(71) Applicant: LG ELECTRONICS INC., Seoul (KR)

(72) Inventors: Daewook BYUN, Seoul (KR); Bokyung BYUN, Seoul (KR); Jian XU, Seoul (KR); Seokjung KIM, Seoul (KR)

(73) Assignee: LG ELECTRONICS INC., Seoul (KR)

(21) Appl. No.: 17/420,119

(22) PCT Filed: Jan. 16, 2020
(86) PCT No.: PCT/KR2020/000771

§ 371 Date: Jun. 30, 2021

(30) Foreign Application Priority Data
Jan. 16, 2019 (KR) 10-2019-0005974

(51) Int. Cl. H04W 76/15; H04W 72/04; H04W 74/08

(52) U.S. Cl. CPC H04W 76/15; H04W 74/0833; H04W 72/04

(57) ABSTRACT

A method and apparatus for controlling radio resource of a redundant route for a dual-connecting Integrated Access and Backhaul (IAB) node in a wireless communication system will be provided. The CU of the IAB-donor is connected with a dual-connecting IAB-node via a master cell group (MCG) IAB-node. The CU of the IAB-donor initiates an establishment of a connection with the dual-connecting IAB-node via a secondary cell group (SCG) IAB-node. The CU of the IAB-donor transmits, to the SCG IAB-node, a first information which informs not allocating radio resource for a bearer. The CU of the IAB-donor determines to use the connection with the dual-connecting IAB-node via the SCG IAB-node. The CU of the IAB-donor transmits, to the SCG IAB-node, a second information to request allocating the radio resource for the bearer.

### TECHNICAL FIELD

The present disclosure relates to a method and apparatus for controlling radio resource of a redundant route for a dual-connecting Integrated Access and Backhaul (IAB) node in a wireless communication system.

### RELATED ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

One of the potential technologies targeted to enable future cellular network deployment scenarios and applications is the support for wireless backhaul and relay links enabling flexible and very dense deployment of NR cells without the need for densifying the wired transport network proportionately.

The operation of access and backhaul may be on the same or different frequencies (also termed ‘in-band’ and ‘out-of-band’ relays). While efficient support of out-of-band relays is important for some NR deployment scenarios, it is critically important to support in-band operation which implies tighter interworking with the access links operating on the same frequency to accommodate duplex constraints and avoid/mitigate interference.

Due to the short range of mmWave access, extension of wireless backhauling to multiple hops is an essential feature. Such multi-hop backhauling also enhances flexibility when using self-backhauling in dense urban environments, where the backhaul path needs to adapt to the infrastructure. While the typical number of backhaul hops is expected to be small (e.g. 1-4), the architecture should not principally restrict the hop count so that larger hop count can be supported.

Further, operating NR systems in mmWave spectrum presents some unique challenges including experiencing severe short-term blocking. Overcoming short-term blocking in mmWave systems requires RAN-based mechanisms for switching between IAB-nodes with little or no involvement of the core network. The above described need to mitigate short-term blocking for NR operation in mmWave spectrum along with the desire for easier deployment of self-backhauled NR cells creates a need for the development of an integrated framework that allows fast switching of access and backhaul links.

Finally, the integrated access and backhaul system should be compliant with SA and NSA deployments in that IAB-nodes can operate in SA or NSA mode, meaning that support needs to be provided for dual connectivity (both EN-DC and NR-DC) for both UEs and IAB-nodes.

IAB is very beneficial for NR rollout and during the early phases of the initial growth phase. Consequently, postponing IAB-related work to a later stage may have adverse impact on the timely deployment of NR access.

### SUMMARY

IAB network includes IAB donor and IAB node(s) which have the relation of a central unit (CU) and a distributed unit (DU) defined in 5G NR. The requirements for IAB design such as multi-hop and redundant connectivity, and end-to-end routing selection and optimization should be addressed.

When redundant route is added for load balancing, the IAB donor CU migrates traffic for the UE to the redundant route. In this case, radio resource allocation for redundant route is necessary.

However, it is not always need to allocate radio resource for the redundant route. For example, allocating radio resource for the redundant route may be unnecessary, while the IAB donor CU does not use the redundant route. In addition, if the redundant route is added for link blockage, the redundant route may not be used until link blockage happens.

Therefore, the studies for avoiding unnecessary radio resource allocation is necessary.

In an aspect, a method performed by a central unit (CU) of an integrated access and backhaul (IAB)-donor in a wireless communication system is provided. The CU of the IAB-donor is connected with a dual-connecting IAB-node via a master cell group (MCG) IAB-node. The CU of the IAB-donor initiates an establishment of a connection with the dual-connecting IAB-node via a secondary cell group (SCG) IAB-node. The CU of the IAB-donor transmits, to the SCG IAB-node, a first information which informs not allocating radio resource for a bearer. The CU of the IAB-donor determines to use the connection with the dual-connecting IAB-node via the SCG IAB-node. The CU of the IAB-donor transmits, to the SCG IAB-node, a second information to request allocating the radio resource for the bearer.

In another aspect, a method performed by a secondary cell group (SCG) integrated access and backhaul (IAB)-node in a wireless communication system is provided. The SCG IAB-node receives, a central unit (CU) of a IAB-donor, a first information which informs not allocating radio resource for a bearer. The CU of the IAB donor is connected with a dual-connecting IAB-node via a master cell group (MCG) IAB-node. The SCG IAB-node receives, from the CU of the IAB-donor, a second information to request allocating the radio resource for the bearer. The SCG IAB-node allocates the radio resource for the bearer. The SCG IAB-node performs a communication with the dual-connecting IAB-node based on the radio resource for the bearer.

The present disclosure may have various advantageous effects.

According to some embodiments of the present disclosure, an apparatus and a method for controlling radio resource of a redundant route for a dual-connecting Integrated Access and Backhaul (IAB) node in a wireless communication system is provided.

For example, the SCG IAB node DU may not allocate the radio resource to bearer(s) to be established during adding the redundant route.

For example, the SCG IAB node DU may not allocate the radio resource to the bearer(s) until link blockage between the dual-connecting IAB node MT and the MCG IAB node DU happens. For other example, the SCG IAB node DU may not allocate the radio resource to the bearer(s) until the load balancing over both routes is needed.

For example, the SCG IAB node DU could use its radio resource efficiently before link blockage case or load balancing case. That is, experience of UE or the IAB node MT could be better (for example, seamless IAB node DU change).

For other example, after adding redundant route, the SCG IAB node DU may not allocate the radio resource to established bearer(s) when the IAB donor CU realizes that the redundant route is not used.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows examples of 5G usage scenarios to which the technical features of the present disclosure can be applied.

FIG. 2 shows an example of a wireless communication system to which the technical features of the present disclosure can be applied.

FIG. 3 shows another example of a wireless communication system to which the technical features of the present disclosure can be applied.

FIG. 4 shows another example of a wireless communication system to which the technical features of the present disclosure can be applied.

FIG. 5 shows a block diagram of a user plane protocol stack to which the technical features of the present disclosure can be applied.

FIG. 6 shows a block diagram of a control plane protocol stack to which the technical features of the present disclosure can be applied.

FIG. 7 shows an example of the overall architecture of an NG-RAN to which technical features of the present disclosure can be applied.

FIG. 8 shows an interface protocol structure for F1-C to which technical features of the present disclosure can be applied.

FIG. 9 shows a reference diagram for IAB in standalone mode, which contains one IAB-donor and multiple IAB-nodes, to which the technical features of the present disclosure can be applied.

FIG. 10 shows an example of overall architecture of IAB to which the technical features of the present disclosure can be applied.

FIG. 11 shows another example of a wireless communication system to which the technical features of the present disclosure can be applied.

FIG. 12 shows an apparatus to which the technical features of the present disclosure can be applied.

FIGS. 13A and 13B show an example diagram for topology adaptation to create redundant routes for an IAB-node.

FIG. 14 shows an example of a method for controlling radio resource of a redundant route for a dual-connecting IAB node in a wireless communication system.

FIG. 15 shows an example of a method for controlling radio resource of a redundant route for a dual-connecting IAB node in a wireless communication system.

FIGS. 16A and 16B show an example of a wireless system for controlling radio resource of a redundant route for a dual-connecting IAB node in a wireless communication system, according to some embodiments of the present disclosure.

FIGS. 17A and 17B show an example of a wireless system for controlling radio resource of a redundant route for a dual-connecting IAB node in a wireless communication system, according to some embodiments of the present disclosure.

FIG. 18 shows an example of an AI device to which the technical features of the present disclosure can be applied.

FIG. 19 shows an example of an AI system to which the technical features of the present disclosure can be applied.

### DESCRIPTION

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (UL). For example, only OFDMA may be used for DL and only SC-FDMA may be used for UL. Alternatively, OFDMA and SC-FDMA may be used for DL and/or UL.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

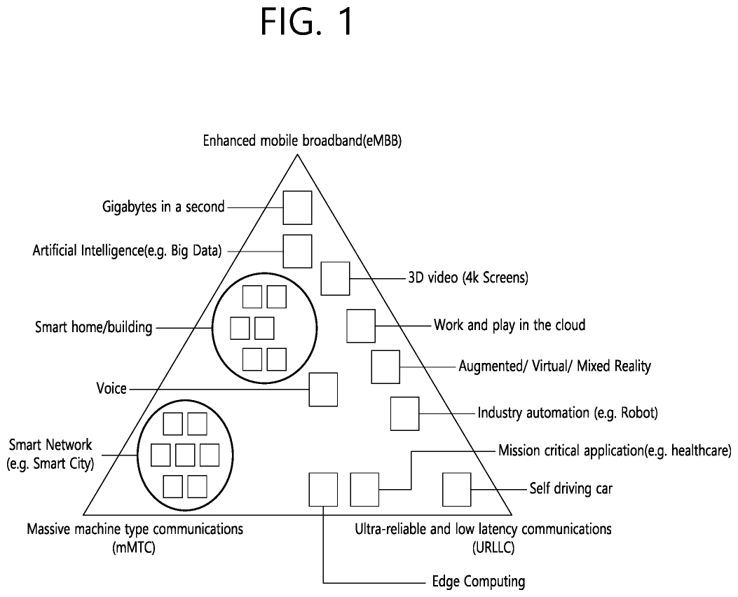

FIG. 1 shows examples of 5G usage scenarios to which the technical features of the present disclosure can be applied.

The 5G usage scenarios shown in FIG. 1 are only exemplary, and the technical features of the present disclosure can be applied to other 5G usage scenarios which are not shown in FIG. 1.

Referring to FIG. 1, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km2. mMTC allows seamless integration of embedded sensors in all areas and is one of the most widely used 5G applications. Potentially by 2020, internet-of-things (IoT) devices are expected to reach 20.4 billion. Industrial IoT is one of the areas where 5G plays a key role in enabling smart cities, asset tracking, smart utilities, agriculture, and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. 1 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time high-definition (HD) video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems. Use cases of logistics and freight tracking typically require low data rates, but require a large range and reliable location information.

NR supports multiple numerology (or, subcarrier spacing (SCS)) to support various 5G services. For example, when the SCS is 15 kHz, wide area in traditional cellular bands may be supported. When the SCS is 30 kHz/60 kHz, dense-urban, lower latency and wider carrier bandwidth may be supported. When the SCS is 60 kHz or higher, a bandwidth greater than 24.25 GHz may be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency | Corresponding | |
|---|---|---|
| Range designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency | Corresponding | |
|---|---|---|
| Range designation | frequency range | Subcarrier Spacing |
| FR1 | 410 MHz-7125 MHz | 15, 30, 60 kHz |
| FR2 | 24250 MHz-52600 MHz | 60, 120, 240 kHz |

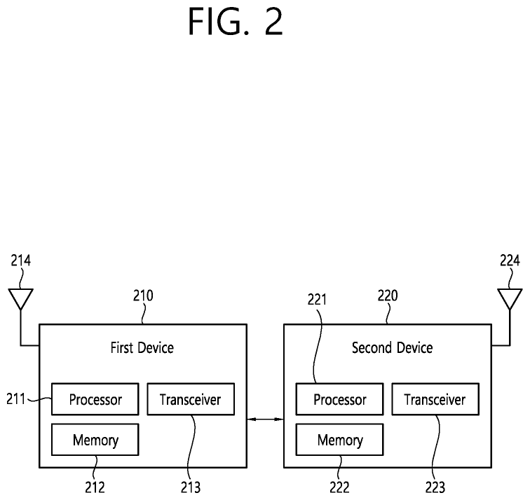

FIG. 2 shows an example of a wireless communication system to which the technical features of the present disclosure can be applied. Referring to FIG. 2, the wireless communication system may include a first device 210 and a second device 220. The first device 210 includes a base station, a network node, a transmitting UE, a receiving UE, a wireless device, a wireless communication device, a vehicle, a vehicle equipped with an autonomous driving function, a connected car, a drone, an unmanned aerial vehicle (UAV), an artificial intelligence (AI) module, a robot, an AR device, a VR device, a mixed reality (MR) device, a hologram device, a public safety device, an MTC device, an IoT device, a medical device, a fin-tech device (or, a financial device), a security device, a climate/environmental device, a device related to 5G services, or a device related to the fourth industrial revolution.

The second device 220 includes a base station, a network node, a transmitting UE, a receiving UE, a wireless device, a wireless communication device, a vehicle, a vehicle equipped with an autonomous driving function, a connected car, a drone, a UAV, an AI module, a robot, an AR device, a VR device, an MR device, a hologram device, a public safety device, an MTC device, an IoT device, a medical device, a fin-tech device (or, a financial device), a security device, a climate/environmental device, a device related to 5G services, or a device related to the fourth industrial revolution.

For example, the UE may include a mobile phone, a smart phone, a laptop computer, a digital broadcasting terminal, a personal digital assistant (PDA), a portable multimedia player (PMP), a navigation device, a slate personal computer (PC), a tablet PC, an ultrabook, a wearable device (e.g. a smartwatch, a smart glass, a head mounted display (HMD)). For example, the HMD may be a display device worn on the head. For example, the HMD may be used to implement AR, VR and/or MR.

For example, the drone may be a flying object that is flying by a radio control signal without a person boarding it. For example, the VR device may include a device that implements an object or background in the virtual world. For example, the AR device may include a device that implements connection of an object and/or a background of a virtual world to an object and/or a background of the real world. For example, the MR device may include a device that implements fusion of an object and/or a background of a virtual world to an object and/or a background of the real world. For example, the hologram device may include a device that implements a 360-degree stereoscopic image by recording and playing stereoscopic information by utilizing a phenomenon of interference of light generated by the two laser lights meeting with each other, called holography. For example, the public safety device may include a video relay device or a video device that can be worn by the user's body. For example, the MTC device and the IoT device may be a device that do not require direct human intervention or manipulation. For example, the MTC device and the IoT device may include a smart meter, a vending machine, a thermometer, a smart bulb, a door lock and/or various sensors. For example, the medical device may be a device used for the purpose of diagnosing, treating, alleviating, handling, or preventing a disease. For example, the medical device may be a device used for the purpose of diagnosing, treating, alleviating, or correcting an injury or disorder. For example, the medical device may be a device used for the purpose of inspecting, replacing or modifying a structure or function. For example, the medical device may be a device used for the purpose of controlling pregnancy. For example, the medical device may include a treatment device, a surgical device, an (in vitro) diagnostic device, a hearing aid and/or a procedural device, etc. For example, a security device may be a device installed to prevent the risk that may occur and to maintain safety. For example, the security device may include a camera, a closed-circuit TV (CCTV), a recorder, or a black box. For example, the fin-tech device may be a device capable of providing financial services such as mobile payment. For example, the fin-tech device may include a payment device or a point of sales (POS). For example, the climate/environmental device may include a device for monitoring or predicting the climate/environment.

The first device 210 may include at least one or more processors, such as a processor 211, at least one memory, such as a memory 212, and at least one transceiver, such as a transceiver 213. The processor 211 may perform the functions, procedures, and/or methods of the present disclosure described below. The processor 211 may perform one or more protocols. For example, the processor 211 may perform one or more layers of the air interface protocol. The memory 212 is connected to the processor 211 and may store various types of information and/or instructions. The transceiver 213 is connected to the processor 211 and may be controlled to transmit and receive wireless signals.

The second device 220 may include at least one or more processors, such as a processor 221, at least one memory, such as a memory 222, and at least one transceiver, such as a transceiver 223. The processor 221 may perform the functions, procedures, and/or methods of the present disclosure described below. The processor 221 may perform one or more protocols. For example, the processor 221 may perform one or more layers of the air interface protocol. The memory 222 is connected to the processor 221 and may store various types of information and/or instructions. The transceiver 223 is connected to the processor 221 and may be controlled to transmit and receive wireless signals.

The memory 212, 222 may be connected internally or externally to the processor 211, 221, or may be connected to other processors via a variety of technologies such as wired or wireless connections.

The first device 210 and/or the second device 220 may have more than one antenna. For example, antenna 214 and/or antenna 224 may be configured to transmit and receive wireless signals.

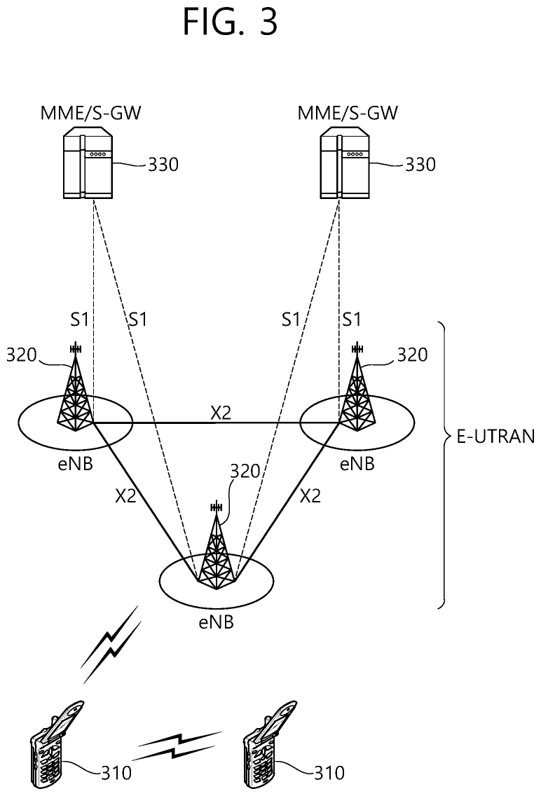

FIG. 3 shows another example of a wireless communication system to which the technical features of the present disclosure can be applied. Specifically, FIG. 3 shows a system architecture based on an evolved-UMTS terrestrial radio access network (E-UTRAN). The aforementioned LTE is a part of an evolved-UTMS (e-UMTS) using the E-UTRAN.

Referring to FIG. 3, the wireless communication system includes one or more user equipment (UE) 310, an E-UTRAN and an evolved packet core (EPC). The UE 310 refers to a communication equipment carried by a user. The UE 310 may be fixed or mobile. The UE 310 may be referred to as another terminology, such as a mobile station (MS), a user terminal (UT), a subscriber station (SS), and a wireless device, etc.

The E-UTRAN consists of one or more evolved NodeB (eNB) 320. The eNB 320 provides the E-UTRA user plane and control plane protocol terminations towards the UE 10. The eNB 320 is generally a fixed station that communicates with the UE 310. The eNB 320 hosts the functions, such as inter-cell radio resource management (RRM), radio bearer (RB) control, connection mobility control, radio admission control, measurement configuration/provision, dynamic resource allocation (scheduler), etc. The eNB 320 may be referred to as another terminology, such as a base station (BS), a base transceiver system (BTS), an access point (AP), etc.

A downlink (DL) denotes communication from the eNB 320 to the UE 310. An uplink (UL) denotes communication from the UE 310 to the eNB 320. A sidelink (SL) denotes communication between the UEs 310. In the DL, a transmitter may be a part of the eNB 320, and a receiver may be a part of the UE 310. In the UL, the transmitter may be a part of the UE 310, and the receiver may be a part of the eNB 320. In the SL, the transmitter and receiver may be a part of the UE 310.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 330 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 310 is connected to the eNB 320 by means of the Uu interface. The UEs 310 are interconnected with each other by means of the PC5 interface. The eNBs 320 are interconnected with each other by means of the X2 interface. The eNBs 320 are also connected by means of the S1 interface to the EPC, more specifically to the MME by means of the S1-MME interface and to the S-GW by means of the S1-U interface. The S1 interface supports a many-to-many relation between MMEs/S-GWs and eNBs.

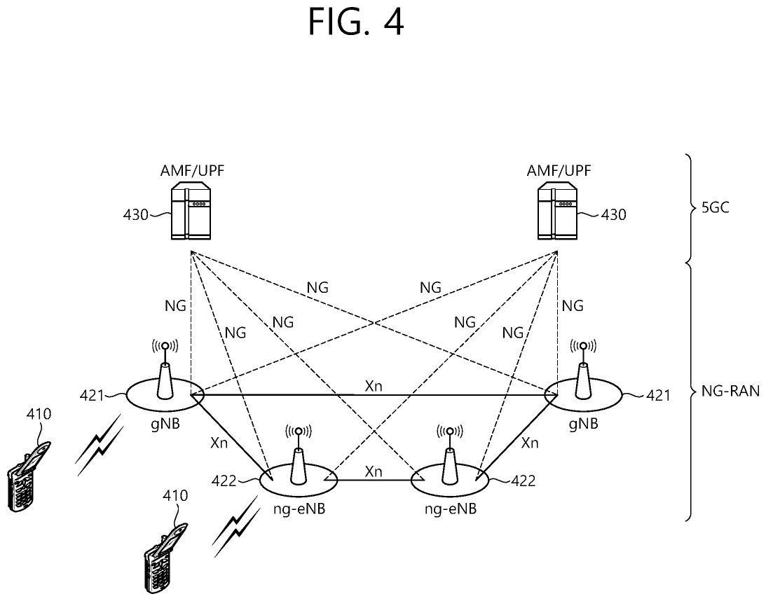

FIG. 4 shows another example of a wireless communication system to which the technical features of the present disclosure can be applied. Specifically, FIG. 4 shows a system architecture based on a 5G NR. The entity used in the 5G NR (hereinafter, simply referred to as “NR”) may absorb some or all of the functions of the entities introduced in FIG. 3 (e.g. eNB, MME, S-GW). The entity used in the NR may be identified by the name “NG” for distinction from the LTE/LTE-A.

Referring to FIG. 4, the wireless communication system includes one or more UE 410, a next-generation RAN (NG-RAN) and a 5th generation core network (5GC). The NG-RAN consists of at least one NG-RAN node. The NG-RAN node is an entity corresponding to the eNB 320 shown in FIG. 3. The NG-RAN node consists of at least one gNB 421 and/or at least one ng-eNB 422. The gNB 421 provides NR user plane and control plane protocol terminations towards the UE 410. The ng-eNB 422 provides E-UTRA user plane and control plane protocol terminations towards the UE 410.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional 5-GW. The SMF hosts the functions, such as UE IP address allocation, PDU session control.

The gNBs 421 and ng-eNBs 422 are interconnected with each other by means of the Xn interface. The gNBs 421 and ng-eNBs 422 are also connected by means of the NG interfaces to the 5GC, more specifically to the AMF by means of the NG-C interface and to the UPF by means of the NG-U interface.

A protocol structure between network entities described above is described. On the system of FIG. 3 and/or FIG. 4, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

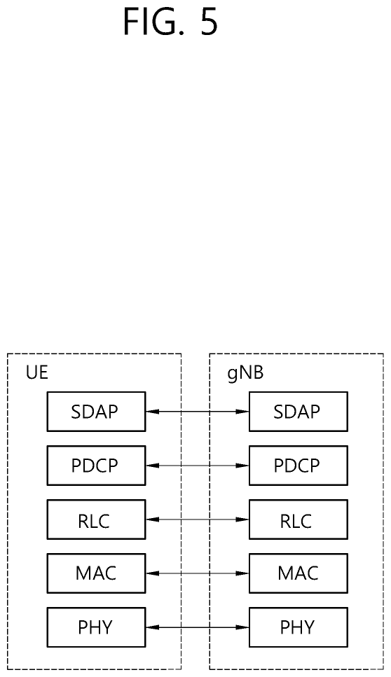

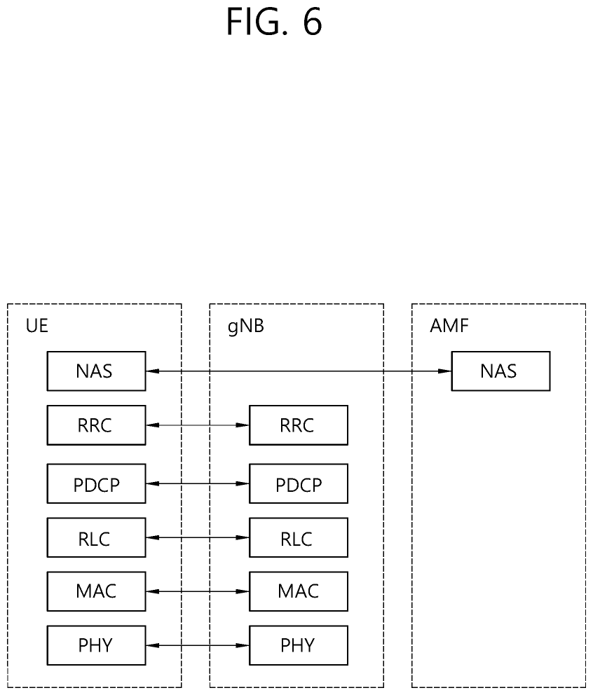

FIG. 5 shows a block diagram of a user plane protocol stack to which the technical features of the present disclosure can be applied. FIG. 6 shows a block diagram of a control plane protocol stack to which the technical features of the present disclosure can be applied. The user/control plane protocol stacks shown in FIG. 5 and FIG. 6 are used in NR. However, user/control plane protocol stacks shown in FIG. 5 and FIG. 6 may be used in LTE/LTE-A without loss of generality, by replacing gNB/AMF with eNB/MME.

Referring to FIG. 5 and FIG. 6, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARD), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

Split of gNB central unit (gNB-CU) and gNB distributed unit (gNB-DU) is described. Section 6 of 3GPP TS 38.401 V15.4.0 (2018-12) and Sections 5.2 and 7.1 of 3GPP TS 38.470 V15.4.0 (2018-12) may be referred.

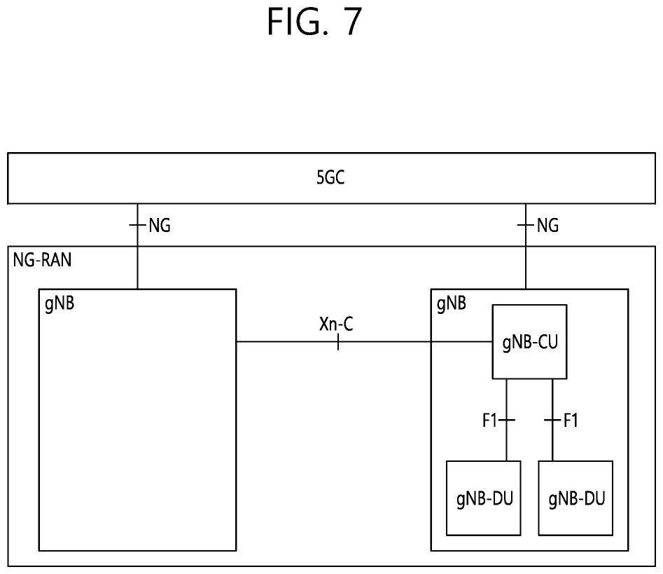

FIG. 7 shows an example of the overall architecture of an NG-RAN to which technical features of the present disclosure can be applied.

Referring to FIG. 7, a gNB may include a gNB-CU (hereinafter, gNB-CU may be simply referred to as CU) and at least one gNB-DU (hereinafter, gNB-DU may be simply referred to as DU).

The gNB-CU is a logical node hosting RRC, SDAP and PDCP protocols of the gNB or an RRC and PDCP protocols of the en-gNB. The gNB-CU controls the operation of the at least one gNB-DU.

The gNB-DU is a logical node hosting RLC, MAC, and physical layers of the gNB or the en-gNB. The operation of the gNB-DU is partly controlled by the gNB-CU. One gNB-DU supports one or multiple cells. One cell is supported by only one gNB-DU.

The gNB-CU and gNB-DU are connected via an F1 interface. The gNB-CU terminates the F1 interface connected to the gNB-DU. The gNB-DU terminates the F1 interface connected to the gNB-CU. One gNB-DU is connected to only one gNB-CU. However, the gNB-DU may be connected to multiple gNB-CUs by appropriate implementation. The F1 interface is a logical interface. For NG-RAN, the NG and Xn-C interfaces for a gNB consisting of a gNB-CU and gNB-DUs, terminate in the gNB-CU. For E-UTRAN-NR dual connectivity (EN-DC), the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

Functions of the F1 interface includes F1 control (F1-C) functions as follows.

(1) F1 Interface Management Function

The error indication function is used by the gNB-DU or gNB-CU to indicate to the gNB-CU or gNB-DU that an error has occurred.

The reset function is used to initialize the peer entity after node setup and after a failure event occurred. This procedure can be used by both the gNB-DU and the gNB-CU.

The F1 setup function allows to exchange application level data needed for the gNB-DU and gNB-CU to interoperate correctly on the F1 interface. The F1 setup is initiated by the gNB-DU.

The gNB-CU configuration update and gNB-DU configuration update functions allow to update application level configuration data needed between gNB-CU and gNB-DU to interoperate correctly over the F1 interface, and may activate or deactivate cells.

The F1 setup and gNB-DU configuration update functions allow to inform the single network slice selection assistance information (S-NSSAI) supported by the gNB-DU.

The F1 resource coordination function is used to transfer information about frequency resource sharing between gNB-CU and gNB-DU.

(2) System Information Management Function

Scheduling of system broadcast information is carried out in the gNB-DU. The gNB-DU is responsible for transmitting the system information according to the scheduling parameters available.

The gNB-DU is responsible for the encoding of NR master information block (MIB). In case broadcast of system information block type-1 (SIB1) and other SI messages is needed, the gNB-DU is responsible for the encoding of SIB1 and the gNB-CU is responsible for the encoding of other SI messages.

(3) F1 UE Context Management Function

The F1 UE context management function supports the establishment and modification of the necessary overall UE context.

The establishment of the F1 UE context is initiated by the gNB-CU and accepted or rejected by the gNB-DU based on admission control criteria (e.g., resource not available).

The modification of the F1 UE context can be initiated by either gNB-CU or gNB-DU. The receiving node can accept or reject the modification. The F1 UE context management function also supports the release of the context previously established in the gNB-DU. The release of the context is triggered by the gNB-CU either directly or following a request received from the gNB-DU. The gNB-CU request the gNB-DU to release the UE Context when the UE enters RRC_IDLE or RRC_INACTIVE.

This function can be also used to manage DRBs and SRBs, i.e., establishing, modifying and releasing DRB and SRB resources. The establishment and modification of DRB resources are triggered by the gNB-CU and accepted/rejected by the gNB-DU based on resource reservation information and QoS information to be provided to the gNB-DU. For each DRB to be setup or modified, the S-NSSAI may be provided by gNB-CU to the gNB-DU in the UE context setup procedure and the UE context modification procedure.

The mapping between QoS flows and radio bearers is performed by gNB-CU and the granularity of bearer related management over F1 is radio bearer level. For NG-RAN, the gNB-CU provides an aggregated DRB QoS profile and QoS flow profile to the gNB-DU, and the gNB-DU either accepts the request or rejects it with appropriate cause value. To support packet duplication for intra-gNB-DU carrier aggregation (CA), one data radio bearer should be configured with two GPRS tunneling protocol (GTP)-U tunnels between gNB-CU and a gNB-DU.

With this function, gNB-CU requests the gNB-DU to setup or change of the special cell (SpCell) for the UE, and the gNB-DU either accepts or rejects the request with appropriate cause value.

With this function, the gNB-CU requests the setup of the secondary cell(s) (SCell(s)) at the gNB-DU side, and the gNB-DU accepts all, some or none of the SCell(s) and replies to the gNB-CU. The gNB-CU requests the removal of the SCell(s) for the UE.

(4) RRC Message Transfer Function

This function allows to transfer RRC messages between gNB-CU and gNB-DU. RRC messages are transferred over F1-C. The gNB-CU is responsible for the encoding of the dedicated RRC message with assistance information provided by gNB-DU.

(5) Paging Function

The gNB-DU is responsible for transmitting the paging information according to the scheduling parameters provided.

The gNB-CU provides paging information to enable the gNB-DU to calculate the exact paging occasion (PO) and paging frame (PF). The gNB-CU determines the paging assignment (PA). The gNB-DU consolidates all the paging records for a particular PO, PF and PA, and encodes the final RRC message and broadcasts the paging message on the respective PO, PF in the PA.

(6) Warning Messages Information Transfer Function

This function allows to cooperate with the warning message transmission procedures over NG interface. The gNB-CU is responsible for encoding the warning related SI message and sending it together with other warning related information for the gNB-DU to broadcast over the radio interface.

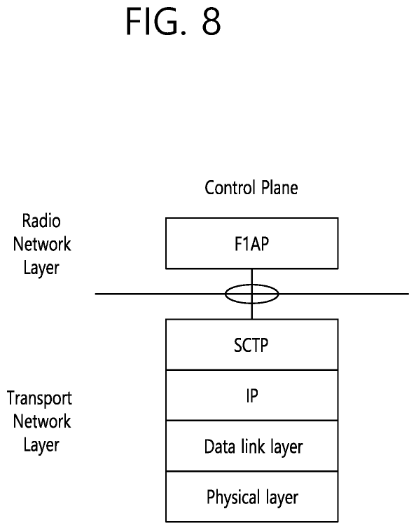

FIG. 8 shows an interface protocol structure for F1-C to which technical features of the present disclosure can be applied.

A transport network layer (TNL) is based on Internet protocol (IP) transport, comprising a stream control transmission protocol (SCTP) layer on top of the IP layer. An application layer signaling protocol is referred to as an F1 application protocol (E1AP).

Integrated access and backhaul (IAB) is described. Section 6 of 3GPP TR 38.874 V16.0.0 (2018-12) can be referred.

IAB-node is a node that provides functionality to support connectivity to the network for the UE via an NR backhaul. IAB-node is a RAN node that supports wireless access to UEs and wirelessly backhauls the access traffic. IAB-donor (or IAB-donor gNB) is a gNB that provides functionality to support an NR backhaul for IAB-nodes. IAB-donor is a RAN node which provides UE's interface to core network and wireless backhauling functionality to IAB-nodes. The IAB-donor and IAB-node(s) may have the relation of gNB-CU and gNB-DU. IAB-donor-CU is the gNB-CU of an IAB-donor gNB, terminating the F1 interface towards IAB-nodes and IAB-donor-DU. IAB-donor-DU is the gNB-DU of an IAB-donor gNB, hosting the IAB backhaul adaptation protocol (BAP) layer, providing wireless backhaul to IAB-nodes. NR backhaul link is NR link used for backhauling between an IAB-node to an IAB-donor, and between IAB-nodes in case of a multi-hop network. The NR backhaul link may be called other names, such as backhaul (BH) RLC channel.

IAB strives to reuse existing functions and interfaces defined for access. In particular, mobile-termination (MT), gNB-DU, gNB-CU, UPF, AMF and SMF as well as the corresponding interfaces NR Uu (between MT and gNB), F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined a component of the mobile equipment. MT is referred to as a function residing on an IAB-node that terminates the radio interface layers of the backhaul Uu interface toward the IAB-donor or other IAB-nodes.

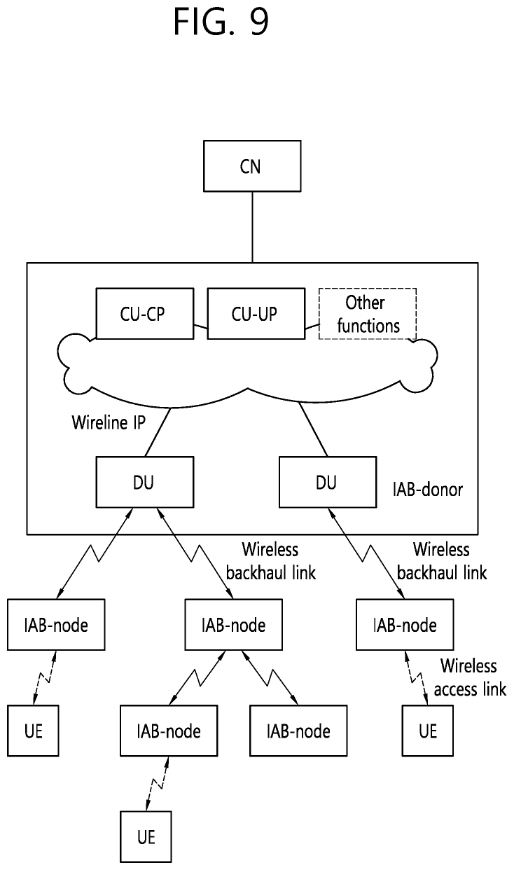

FIG. 9 shows a reference diagram for IAB in standalone mode, which contains one IAB-donor and multiple IAB-nodes, to which the technical features of the present disclosure can be applied.

The IAB-donor is treated as a single logical node that comprises a set of functions such as gNB-DU, gNB-CU control plane (gNB-CU-CP), gNB-CU user plane (gNB-CU-UP) and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

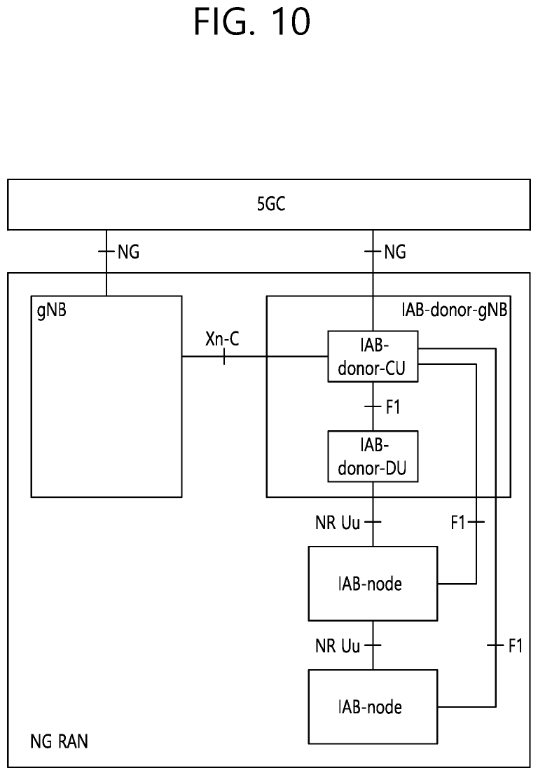

FIG. 10 shows an example of overall architecture of IAB to which the technical features of the present disclosure can be applied.

The NG-RAN supports IAB by the IAB-node wirelessly connecting to the gNB capable of serving the IAB-nodes, named IAB-donor gNB.

The IAB-donor gNB consists of an IAB-donor-CU and one or more IAB-donor-DU(s). In case of separation of gNB-CU-CP and gNB-CU-UP, the IAB-donor gNB may consist of an IAB-donor-CU-CP, multiple IAB-donor-CU-UPs and multiple IAB-donor-DUs.

The IAB-node connects to an upstream IAB-node or an IAB-donor-DU via a subset of the UE functionalities of the NR Uu interface (named IAB-MT function of IAB-node). The IAB-node provides wireless backhaul to the downstream IAB-nodes and UEs via the network functionalities of the NR Uu interface (named IAB-DU function of IAB-node).

The F1-C traffic towards an IAB-node is backhauled via the IAB-donor-DU and the optional intermediate IAB-node(s).

The F1 user plane interface (F1-U) traffic towards an IAB-node is backhauled via the IAB-donor-DU and the optional intermediate IAB-node(s).

All functions specified for a gNB-DU are equally applicable for an IAB-node and IAB-donor-DU unless otherwise stated, and all functions specified for a gNB-CU are equally applicable for an IAB-donor-CU, unless otherwise stated. All functions specified for the UE context are equally applicable for managing the context of IAB-node MT functionality, unless otherwise stated.

The requirements for IAB design such as multi-hop and redundant connectivity, and end-to-end routing selection and optimization, should be addressed. For example, considering these requirements, the IAB-node may have multi-hop connection with the IAB-donor-CU.

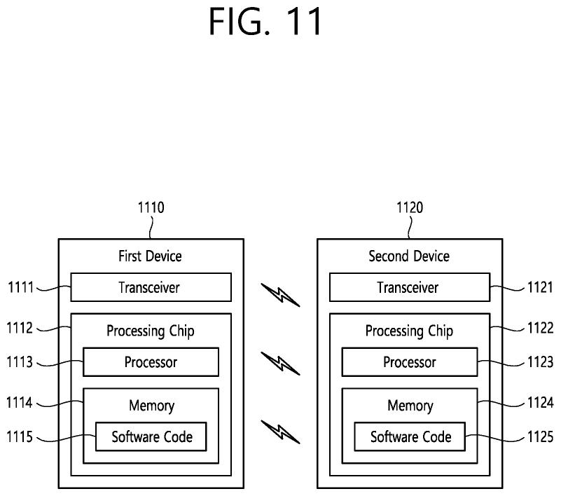

FIG. 11 shows another example of a wireless communication system to which the technical features of the present disclosure can be applied.

Referring to FIG. 11, the wireless communication system may include a first device 1110 and a second device 1120.

The first device 1110 may include at least one transceiver, such as a transceiver 1111, and at least one processing chip, such as a processing chip 1112. The processing chip 1112 may include at least one processor, such a processor 1113, and at least one memory, such as a memory 1114. The memory may be operably connectable to the processor 1113. The memory 1114 may store various types of information and/or instructions. The memory 1114 may store a software code 1115 which implements instructions that, when executed by the processor 1113, perform operations of the present disclosure described below. For example, the software code 1115 may implement instructions that, when executed by the processor 1113, perform the functions, procedures, and/or methods of the present disclosure described below. For example, the software code 1115 may control the processor 1113 to perform one or more protocols. For example, the software code 1115 may control the processor 1113 may perform one or more layers of the radio interface protocol.

The second device 1120 may include at least one transceiver, such as a transceiver 1121, and at least one processing chip, such as a processing chip 1122. The processing chip 1122 may include at least one processor, such a processor 1123, and at least one memory, such as a memory 1124. The memory may be operably connectable to the processor 1123. The memory 1124 may store various types of information and/or instructions. The memory 1124 may store a software code 1125 which implements instructions that, when executed by the processor 1123, perform operations of the present disclosure described below. For example, the software code 1125 may implement instructions that, when executed by the processor 1123, perform the functions, procedures, and/or methods of the present disclosure described below. For example, the software code 1125 may control the processor 1123 to perform one or more protocols. For example, the software code 1125 may control the processor 1123 may perform one or more layers of the radio interface protocol.

According to some embodiment of the present disclosure, the technical features of the present disclosure could be embodied directly in hardware, in a software executed by a processor, or in a combination of the two. For example, a method performed by a first core network node in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

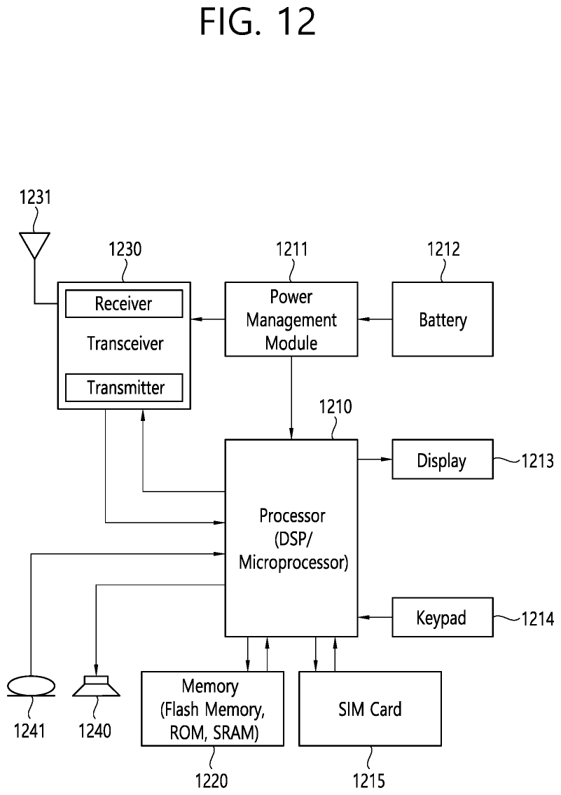

FIG. 12 shows an apparatus to which the technical features of the present disclosure can be applied. The detailed description of the same features as those described above will be simplified or omitted.

An apparatus may be referred to as a wireless device, such as a user equipment (UE), an Integrated Access and Backhaul (IAB), or etc.

A wireless device includes a processor 1210, a power management module 1211, a battery 1212, a display 1213, a keypad 1214, a subscriber identification module (SIM) card 1215, a memory 1220, a transceiver 1230, one or more antennas 1231, a speaker 1240, and a microphone 1241.

The processor 1210 may be configured to implement proposed functions, procedures and/or methods described in this description. Layers of the radio interface protocol may be implemented in the processor 1210. The processor 1210 may include application-specific integrated circuit (ASIC), other chipset, logic circuit and/or data processing device. The processor 1210 may be an application processor (AP). The processor 1210 may include at least one of a digital signal processor (DSP), a central processing unit (CPU), a graphics processing unit (GPU), a modem (modulator and demodulator). An example of the processor 1210 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The power management module 1211 manages power for the processor 1210 and/or the transceiver 1230. The battery 1212 supplies power to the power management module 1211. The display 1213 outputs results processed by the processor 1210. The keypad 1214 receives inputs to be used by the processor 1210. The keypad 1214 may be shown on the display 1213. The SIM card 1215 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 1220 is operatively coupled with the processor 1210 and stores a variety of information to operate the processor 1210. The memory 1220 may include read-only memory (ROM), random access memory (RAM), flash memory, memory card, storage medium and/or other storage device. When the embodiments are implemented in software, the techniques described herein can be implemented with modules (e.g., procedures, functions, and so on) that perform the functions described herein. The modules can be stored in the memory 1220 and executed by the processor 1210. The memory 1220 can be implemented within the processor 1210 or external to the processor 1210 in which case those can be communicatively coupled to the processor 1210 via various means as is known in the art.

The transceiver 1230 is operatively coupled with the processor 1210, and transmits and/or receives a radio signal. The transceiver 1230 includes a transmitter and a receiver. The transceiver 1230 may include baseband circuitry to process radio frequency signals. The transceiver 1230 controls the one or more antennas 1231 to transmit and/or receive a radio signal.

The speaker 1240 outputs sound-related results processed by the processor 1210. The microphone 1241 receives sound-related inputs to be used by the processor 1210.

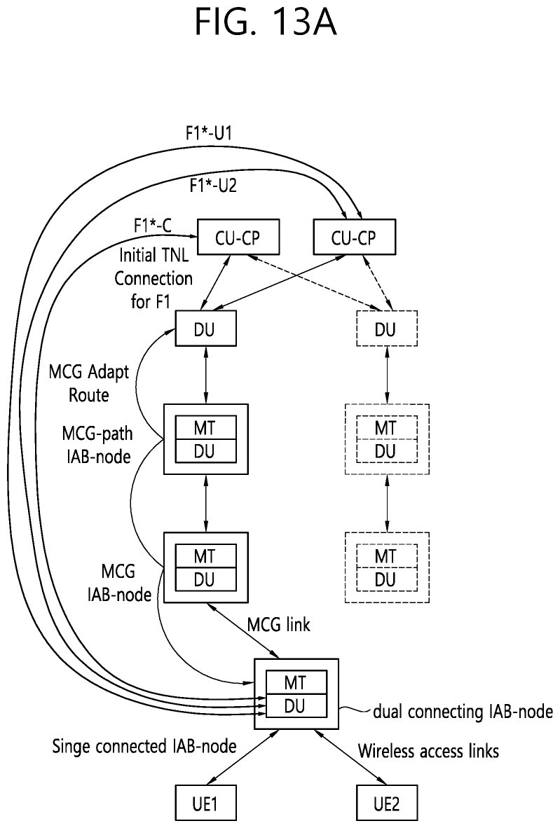

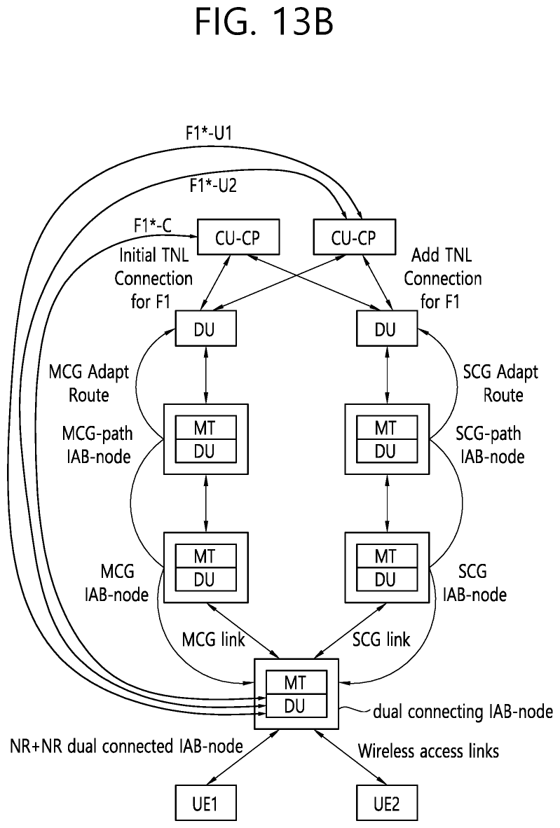

FIGS. 13A and 13B show an example diagram for topology adaptation to create redundant routes for an IAB-node. In particular, FIGS. 13A and 13B show a spanning tree (ST) topology with five IAB-nodes connected to an IAB-donor which holds two DUs. Section 9.7 of 3GPP TR 38.874 V16.0.0 (2018-12) can be referred.

IAB network includes IAB donor and IAB node(s). IAB node is defined as RAN node that supports wireless access to UEs and wirelessly backhauls the access traffic. Also, IAB donor is defined as RAN node which provides UE's interface to core network and wireless backhauling functionality to IAB nodes. It is assumed that the IAB donor and IAB node(s) have the relation of CU and DU.

In FIG. 13A, a dual-connecting IAB-node may be referred as a single connected IAB-node since the redundant routes is not added yet. In FIG. 13B, a dual-connecting IAB-node may be referred as a dual connected IAB-node since the redundant routes is added.

One IAB-node in this topology, referred to as dual-connecting IAB-node, starts out with an MCG-link to a parent IAB-node DU and it adds an SCG-link to another IAB-node DU.

In this example, the dual-connecting IAB-node has two UE attached, where each UE has a default-bearer established with F1-U GTP-U 1 and F1-U GTP-U 2, respectively. After connecting to the SCG, an additional route is established between the dual-connecting IAB-node DU and the CU via the SCG-path.

Since the new route uses a different IAB-donor DU, its southbound end point is associated with a different IP address on the wireline front haul. The CU can add this IP address as an alternative SCTP endpoint for F1-C to the dual-connecting IAB-node DU.

This is one example of achieving enhanced CP robustness can be achieved for the dual-connecting IAB-node DU. In this example, the CU may further migrate traffic for UE 2 to the new route while it keeps traffic for UE1 at the initial route. In this manner, load is balanced over both routes.

As described above, topological redundancy has the goal to enable robust operation, for example, in case of backhaul link blockage, and to balance load across backhaul links.

In case redundant route is added for load balancing over both routes, as shown in FIGS. 11A and 11B, the IAB donor CU further migrates traffic for UE2 to the new route while it keeps traffic for UE1 at the initial route. In this case, when to add redundant route, radio resource allocation for SCG link is necessary in order to provide traffic to UE2.

However, in case SCG link is not used anymore or it SCG link not used right after adding redundant route, keeping the radio resource allocation for SCG link may be unnecessary.

In addition, in case redundant route is added for link blockage, radio resource allocation for redundant route may be unnecessary. It is because the SCG link is not used until link blockage happens.

Furthermore, in case NR+NR dual connected IAB node as shown in FIGS. 11A and 11B uses single MT function, it is not possible to suspend SCG link while the SCG link is not used. It is because single MT function could not have dual RRC states. For example, a single MT function of a dual-connecting IAB node could not have RRC_CONNECTED state for MCG link and RRC_INATIVE state for SCG link.

Therefore, when added redundant route is not used, the solution which can avoid unnecessary radio resource allocation for it is necessary.

Hereinafter, a method for controlling radio resource of a redundant route for a dual-connecting Integrated Access and Backhaul (IAB) node in a wireless communication system according to some embodiments of the present disclosure will be described with reference to following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

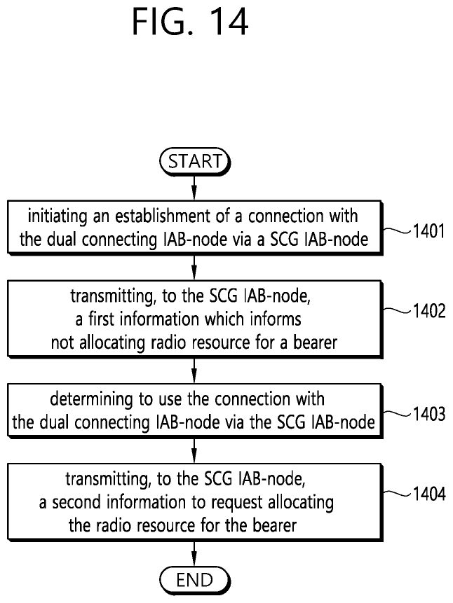

FIG. 14 shows an example of a method for controlling radio resource of a redundant route for a dual-connecting IAB node in a wireless communication system. More specifically, FIG. 14 shows an example of a method performed by a central unit (CU) of an IAB-donor. The CU of the IAB donor may be connected with a dual-connecting IAB-node via a MCG IAB-node.

In step 1401, the CU of the IAB donor may initiate an establishment of a connection with the dual-connecting IAB-node via a secondary cell group (SCG) IAB-node. For example, the CU of the IAB donor may initiate an establishment of a redundant route based on measurement report from the dual-connecting IAB-node. The redundant route may be a SCG path including the CU of the IAB donor, the SCG IAB-node, and the dual-connecting IAB-node. For example, the CU of the IAB donor may initiate to establish at least one of a bearer for the redundant route.

In step 1402, the CU of the IAB donor may transmit, to the SCG IAB-node, a first information which informs not allocating radio resource for a bearer. The bearer may be related to the connection with the dual-connecting IAB-node via the SCG IAB-node. For example, the bearer may be established for the redundant route.

According to some embodiments of the present disclosure, the CU of the IAB donor may transmit, to the SCG IAB-node, a No Resource Allocation Indication which indicates not allocating the radio resource for the bearer. The CU of the IAB donor may establish at least one of a bearer for the redundant route without allocating radio resource upon receiving the first information.

In step 1403, the CU of the IAB donor may determine to use the connection with the dual-connecting IAB-node via the SCG IAB-node. For example, the CU of the IAB donor may determine to use the redundant route for the dual-connecting IAB-node. For other example, the CU of the IAB donor may not determine to use the redundant route for the dual-connecting IAB-node and only use the main route. The main route may include the CU of the IAB donor, the MCG IAB-node, and the dual-connecting IAB-node.

According to some embodiment of the present disclosure, the CU of the IAB donor may receive, from the SCG IAB-node, UE Requested Bearer Status which informs whether allocating the radio resource for the bearer is possible or not. The CU of the IAB donor may know whether the radio resource can be allocated or not to the bearer. In this case, the CU of the IAB donor may consider the UE Requested Bearer Status for determining whether to use the connection with the dual-connecting IAB-node via the SCG IAB-node or not. In other words, the CU of the IAB donor may determine to use the connection with the dual-connecting IAB-node via the SCG IAB-node based on the UE Requested Bearer Status.

For example, when the UE Requested Bearer Status informs that allocating the radio resource for the bearer is not possible, the CU of the IAB donor may determine not to use the redundant route. For other example, when the UE Requested Bearer Status informs that allocating the radio resource for the bearer is possible, the CU of the IAB donor may consider that using the redundant route is possible.

According to some embodiment of the present disclosure, the CU of the IAB donor may receive a third information that link blockage between the MCG IAB-node and the dual-connecting IAB-node occurs. The CU of the IAB donor may determine to use the connection with the dual-connecting IAB-node via the SCG IAB-node based on the third information. The third information may include a link blockage indication.

For example, the CU of the IAB donor may determine to use the connection with the dual-connecting IAB-node via the SCG IAB-node based on the third information and the UE Requested Bearer Status received from the SCG IAB-node.

For example, the third information may be transmitted from the MCG IAB-node as part of a Downlink Data Delivery Status frame. That is, the MCG IAB-node may detect the link blockage between the MCG IAB-node and the dual-connecting IAB-node. The MCG IAB-node may transmit the third information to the CU of the IAB-donor upon detecting that the link blockage occurs.

For other example, the third information may be transmitted from the SCG IAB-node based on that the SCG IAB-node detects a random access of the dual-connecting IAB-node. More specifically, the dual-connecting IAB-node may detect the link blockage between the MCG IAB-node and the dual-connecting IAB-node. The dual-connecting IAB-node may trigger a random access to the SCG IAB-node upon detecting that the link blockage occurs. The SCG IAB-node may recognize that the link blockage occurs based on that the random access of the dual-connecting IAB-node is performed. The SCG IAB-node may transmit the third information (for example, a link blockage indication) to the CU of the IAB-node.

According to some embodiment of the present disclosure, the CU of the IAB donor may determine to use the connection with the dual-connecting IAB-node via the SCG IAB-node based on whether load balancing between the MCG IAB-node and the SCG IAB-node for the dual connected IAB-node is required.

For example, the CU of the IAB donor may determine to use the redundant route for load balancing between the main route and the redundant route. The CU of the IAB donor may distribute the load of the main route to the redundant route. For example, UE1 and UE2 may be connected to the dual-connecting IAB-node. The CU of the IAB-donor may perform a transmission to UE1 using the main route and perform a transmission to UE2 using the redundant route.

In step 1404, the CU of the IAB donor may transmit, to the SCG IAB-node, a second information to request allocating the radio resource for the bearer. The CU of the IAB donor may transmit, to the SCG IAB-node, a second information upon determining to use the connection with the dual-connecting IAB-node via the SCG IAB-node (for example, the redundant route). The second information may be included in a UE Context Modification Request Message. The second information may include a Resource Allocation Indication.

The SCG IAB-node may allocate the radio resource for the bearer upon receiving the second information.

The CU of the IAB donor may perform a transmission to the dual-connecting IAB-node via the SCG IAB-node based on the radio resource for the bearer.

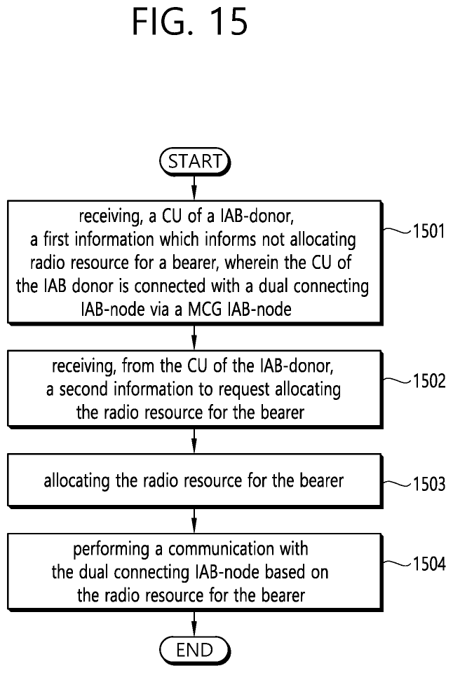

FIG. 15 shows an example of a method for controlling radio resource of a redundant route for a dual-connecting IAB node in a wireless communication system. More specifically, FIG. 15 shows an example of a method performed by a SCG IAB-node in a wireless communication system.

In step 1501, the SCG IAB-node may receive, a CU of an IAB-donor, a first information which informs not allocating radio resource for a bearer. The CU of the IAB donor may be connected with a dual-connecting IAB-node via a master cell group (MCG) IAB-node.

The SCG IAB-node may establish a connection with the dual-connecting IAB-node and the CU of the IAB-donor. The bearer may be related to the connection with the dual-connecting IAB-node and the CU of the IAB-donor via the SCG IAB-node.

For example, the SCG IAB-node may be part of a redundant route. The redundant route may include the CU of the IAB-donor, the SCG IAB-node, and the dual-connecting IAB-node.

The bearer may be related to the connection between the CU of the IAB-donor and the dual-connecting IAB-node via the SCG IAB-node. That is the bearer may be established for the redundant route.

In this case, the MCG IAB-node may be part of a main route. The main route may include the CU of the IAB-donor, the MCG IAB-node, and the dual-connecting IAB-node.

In step 1502, the SCG IAB-node may receive, from the CU of the IAB-donor, a second information to request allocating the radio resource for the bearer. The second information may be included in a UE Context Modification Request Message. The second information may include a Resource Allocation Indication.

According to some embodiments of the present disclosure, the SCG IAB-node may transmit, to the CU of the IAB-donor, UE Requested Bearer Status which informs whether allocating the radio resource for the bearer is possible or not. The CU of the IAB-donor may transmit, to the SCG IAB-node, the second information based on the UE Requested Bearer Status.

According to some embodiments of the present disclosure, the SCG IAB-node may determine that link blockage between the MCG IAB-node and the dual-connecting IAB-node occurs. The SCG IAB-node may transmit, to the CU of the IAB-donor, a third information which informs that the link blockage occurs.

For example, the dual-connecting IAB-node may perform random access to the SCG IAB-node when the link blockage with the MCG IAB-node occurs. The SCG IAB-node may determine that the link blockage occurs based on that random access procedure is triggered by the dual-connecting IAB-node.

For example, the SCG IAB-node mat transmit, to the CU of the IAB-donor, a UE link blockage indication. The SCG IAB-node may receive the second information (for example, resource allocation indication) in response to the third information (for example, UE link blockage indication).

In step 1503, the SCG IAB-node may allocate the radio resource for the bearer. The SCG IAB-node may allocate the radio resource upon receiving the second information.

In step 1504, the SCG IAB-node may perform a communication with the dual-connecting IAB-node based on the radio resource for the bearer.

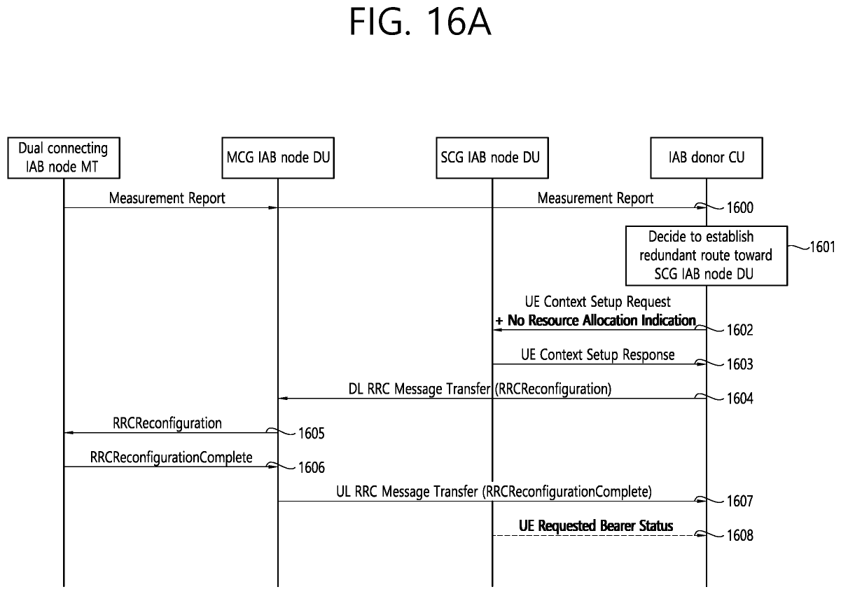

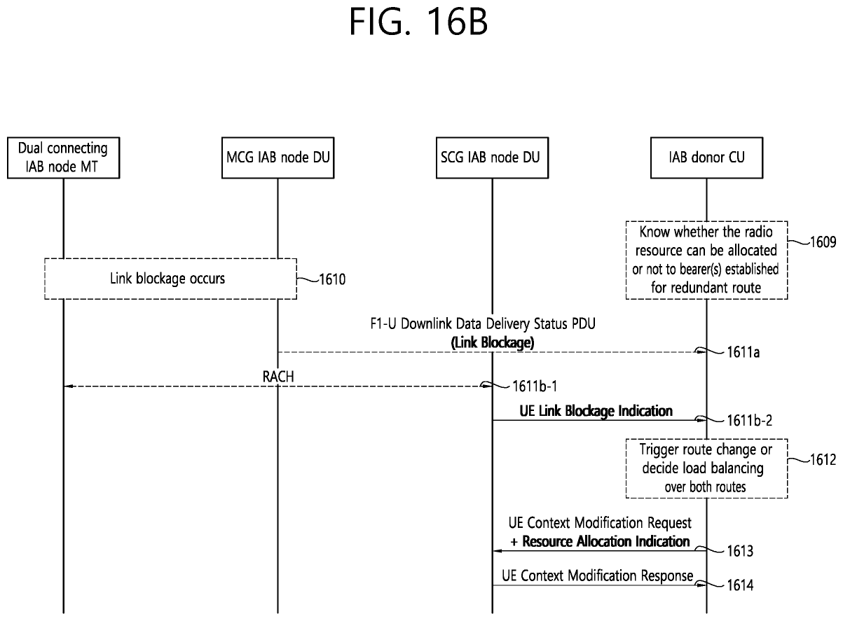

FIGS. 16A and 16B show an example of a wireless system for controlling radio resource of a redundant route for a dual-connecting JAB node in a wireless communication system, according to some embodiments of the present disclosure.

More specifically, in FIGS. 16A and 16B, an IAB donor CU may provide an indication to a SCG IAB node DU. The indication may indicate not allocating the radio resource to bearer(s). The bearer(s) may be established between the dual-connecting IAB node and the SCG IAB node DU. The indication may be provided when the IAB donor CU decides to add redundant route to the dual-connecting JAB node.

In addition, in case link blockage between the dual-connecting IAB node MT and MCG IAB node DU occurs, the MCG IAB node DU or the SCG IAB node DU may notify the TAB donor CU that link blockage happens via F1-U or F1-C respectively in order to request or trigger route change toward already established redundant route. In addition, the SCG IAB node DU may inform the IAB donor CU of whether the radio resource can be allocated or not to bearer(s) established for redundant route.

In step 1600, the dual-connecting IAB node MT may send a MeasurementReport message to the IAB donor CU via the MCG IAB node DU. This report may be based on a measurement configuration the dual-connecting IAB node MT received from the IAB donor CU before.

In step 1601, upon receiving a MeasurementReport message, the IAB donor CU may decide to add redundant route to the dual-connecting IAB node, based on the MeasurementReport message.

In step 1602, the IAB donor CU may send to the SCG IAB node DU the UE Context Setup Request or new message with a No Resource Allocation Indication. The No Resource Allocation Indication may indicate not allocating the radio resource to bearer(s) to be established.

In step 1603, upon receiving the message from the IAB donor CU, the SCG IAB node DU may decide to establish all of or a part of the requested bearer(s) without allocating the radio resource. The SCG IAB node DU may transmit the UE Context Setup Response or new message to the IAB donor CU. The UE Context Setup Response or new message may include an indication that the radio resource for established bearer(s) is not allocated. In addition, after receiving the message with a No Resource Allocation Indication, the SCG IAB node DU may monitor or check whether the radio resource can be allocated or not to bearer(s) established for redundant route.

In step 1604, the IAB donor CU may send the DL RRC Message Transfer message with an RRCReconfiguration message to the MCG IAB node DU.

In step 1605, the MCG IAB node DU forwards an RRCReconfiguration message to the dual-connecting IAB node MT.

In step 1606, the dual-connecting IAB node MT transmits an RRCReconfigurationComplete message to the MCG IAB node DU.

In step 1607, the MCG IAB node DU may send to the IAB donor CU the UL RRC Message Transfer message to forward an RRCReconfigurationComplete message received from the dual-connecting IAB node MT.

In step 1608, after Step 1603, the SCG IAB node DU may monitor or check whether the radio resource can be allocated or not to bearer(s) established for redundant route or not. The SCG IAB node DU may transmit, to the IAB donor CU, a UE Requested Bearer Status, a new message, or an existing message to indicate whether the radio resource can be allocated or not to bearer(s) established for redundant route or not.

According to when the message is sent to the IAB donor CU, one of the following ways may be used. One way is that t the SCG IAB node DU may send the UE Requested Bearer Stat, the new message, or the existing message whenever the radio resource for the established bearer cannot be allocated while it could be done, or vice versa. Another way is that the SCG IAB node DU may periodically transmit the new message, or the existing message to indicate whether the radio resource can be allocated or not to the bearer(s).

According to some embodiments of the present disclosure, step 1608 may be performed optionally.

In step 1609, upon receiving the message in step 1608, the IAB donor CU could know whether the radio resource can be allocated or not to bearer(s) established for redundant route.

In step 1610, link blockage between the dual-connecting IAB node MT and MCG IAB node DU may occur.

According to which node realizes link blockage, one of the following steps may be used.

In step 1611a, in case the MCG IAB node DU realizes link blockage, the MCG IAB node DU may transmit the “Link Blockage” notification message to the IAB donor CU over the F1-U interface, as part of the Downlink Data Delivery Status (DDDS) PDU (or the DDDS frame) of the concerned data radio bearer.

In step 1611b-1, in case the dual-connecting IAB node MT realizes link blockage, case the dual-connecting IAB node MT may trigger the RACH procedure to the SCG IAB node DU.

In step 1611b-2, after performing the RACH procedure, the SCG IAB node DU may perceive link blockage and send the UE Link Blockage Indication, new or existing message to the IAB donor CU in order to request or trigger route change toward already established redundant route.

In step 1612, upon receiving the DDDS PDU (or the DDDS frame) from the MCG IAB node DU or the message from the SCG IAB node DU, the IAB donor CU may determine route change toward already established redundant route. Also, when load is balanced over both routes, the IAB donor CU may decide to use already established redundant route.

In step 1613, the IAB donor CU my sends, to the SCG IAB node DU, a UE Context Modification Request or new message including a Resource Allocation Indication to request allocating radio resource to the established bearer(s). The UE Context Modification Response may be sent to the SCG IAB node DU is response to receiving the UE Context Setup Response in step 1603.

If the IAB donor CU receives the UE Requested Bearer Status in step 1608, the IAB donor CU may transmit to the SCG IAB node DU the UE Context Modification Request or new message including the list of established bearer(s) to which the SCG IAB node DU can allocate the radio resource without a Resource Allocation Indication.

In step 1614, upon receiving the message with an indication, the SCG IAB node DU may decide whether to be able to allocate the radio resource to requested bearer(s). When the SCG IAB node DU receives the message with the indication, the SCG IAB node DU may allocate the radio resource to requested bearer(s). The SCG IAB node DU may send the UE Context Modification Response or new message to the IAB donor CU.

According to some embodiments of the present disclosure, the SCG IAB node DU may not allocate the radio resource to bearer(s) to be established during adding the redundant route.

For example, the SCG IAB node DU may not allocate the radio resource to the bearer(s) until link blockage between the dual-connecting IAB node MT and the MCG IAB node DU happens. For other example, the SCG IAB node DU may not allocate the radio resource to the bearer(s) until the load balancing over both routes is needed.

The SCG IAB node DU could use its radio resource efficiently before link blockage case or load balancing case. Therefore, experience of UE or the IAB node MT could be better (for example, seamless IAB node DU change).

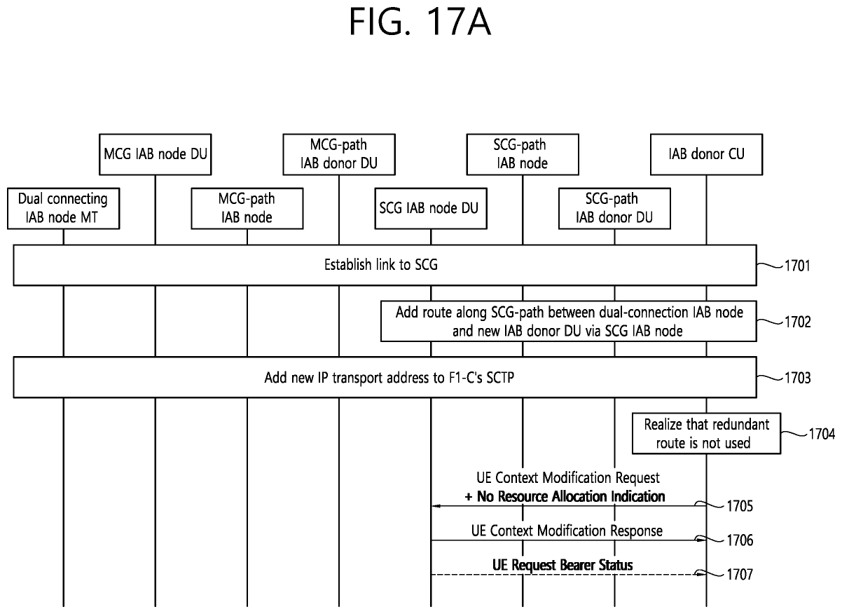

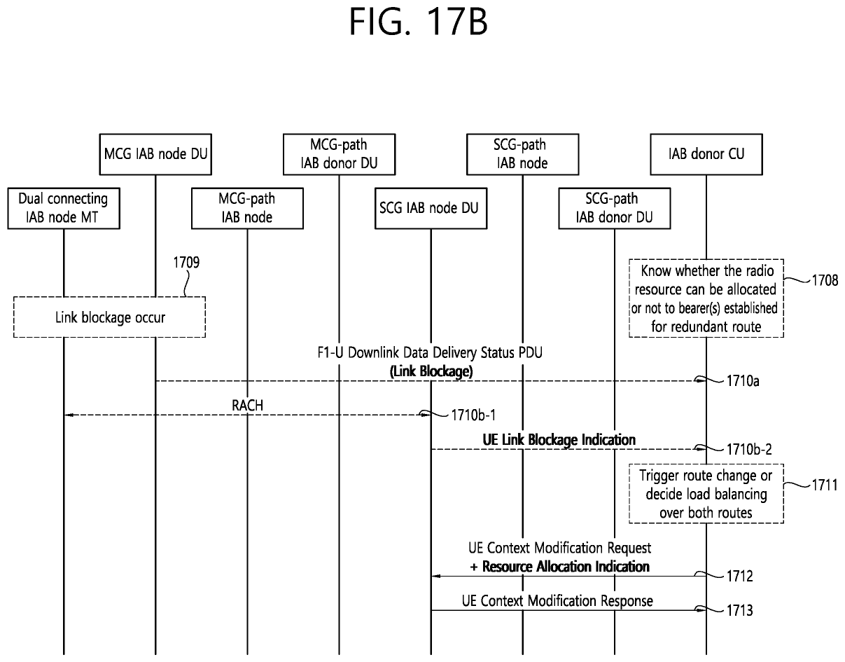

FIGS. 17A and 17B show an example of a wireless system for controlling radio resource of a redundant route for a dual-connecting IAB node in a wireless communication system, according to some embodiments of the present disclosure.

More specifically, in FIGS. 17A and 17B, an IAB donor CU may provide an indication to a SCG IAB node DU. The indication may indicate whether to allocate or not the radio resource to established bearer(s) between the dual-connecting IAB node and the SCG IAB node DU for redundant route. The IAB donor CU may provide the indication when the IAB donor CU realizes that redundant route is not used, link blockage occurs, or load balancing over both routes is required.

In addition, in case link blockage between the dual-connecting IAB node MT and MCG IAB node DU occurs, the MCG IAB node DU or the SCG IAB node DU may notify the IAB donor CU that link blockage happens via F1-U or F1-C respectively in order to request or trigger route change toward already established redundant route. In addition, the SCG IAB node DU may inform the IAB donor CU of whether the radio resource can be allocated or not to bearer(s) established for redundant route.

In step 1701, the dual-connecting IAB node MT may add an SCG-link to the SCG IAB node DU. The dual-connecting IAB node MT may establish link to the SCG IAB node DU via an MCG path. For example, the IAB donor CU, the MCG-path IAB donor DU, the MCG-path IAB node, the MCG IAB node DU, and the dual-connecting IAB node MT may be on the MCG-path.

In step 1702, the IAB donor CU may configure a new adaptation-layer route (SCG-route) on the wireless backhaul between dual-connecting IAB node and an IAB donor DU (for example, a SCG-path IAB donor DU) via the SCG IAB node. For example, the IAB donor CU, the SCG-path IAB donor DU, the SCG-path IAB node, the SCG IAB node DU, and the dual-connecting IAB node MT may be on the SCG-path.

In step 1703, the IAB donor CU may add an alternative Stream Control Transmission Protocol (SCTP) path for F1-C of the dual-connecting IAB node DU.

In step 1704, the IAB donor CU may realize that redundant route is not used when at least one of the following conditions is met. First, there is no signaling between the IAB donor CU and the dual-connecting IAB node MT or DU via the SCG IAB node DU. Second, there is no signaling between the IAB donor CU and the SCG IAB node DU for the dual-connecting IAB node MT. Third, the IAB donor CU receives the UE Inactivity Notification message for the dual-connecting IAB node MT from the SCG IAB node DU.

In step 1705, the IAB donor CU may send, to the SCG IAB node DU, the UE Context Modification Request or new message with a No Resource Allocation Indication. The No Resource Allocation Indication may indicate not allocating the radio resource to bearer(s) established for the redundant route in step 1701.

In step 1706, upon receiving the message from the IAB donor CU, the SCG IAB node DU may not allocate the radio resource to bearer(s) indicated by the IAB donor CU. The SCG IAB node DU may transmit the UE Context Modification Response or new message to the IAB donor CU.

The UE Context Modification Response or new message may include an indication that the radio resource for indicated bearer(s) is not allocated. In addition, after receiving the message with a No Resource Allocation Indication, the SCG IAB node DU may monitor or check whether the radio resource can be allocated or not to bearer(s) established for redundant route.

In step 1707, if the SCG IAB node DU monitors or checks whether the radio resource can be allocated or not to bearer(s) established for redundant route, the SCG IAB node DU may transmit, to the IAB donor CU, the UE Requested Bearer Status, new message, or existing message. The UE Requested Bearer Status, new message, or existing message may indicate whether the radio resource can be allocated or not to bearer(s) established for redundant route.

According to when this message is sent to the IAB donor CU, one of the following ways may be used. One way is that the SCG IAB node DU sends the message whenever the radio resource for the established bearer cannot be allocated while it could be done, or vice versa. Another way is that the SCG IAB node DU periodically transmits the message to indicate whether the radio resource can be allocated or not to bearer(s).

In step 1708, on receiving the message in step 1707, the IAB donor CU could know whether the radio resource can be allocated or not to bearer(s) established for redundant route.

In step 1709, link blockage between the dual-connecting IAB node MT and MCG IAB node DU may occur.

According to which node realizes link blockage, one of the following steps may be used.

In step 1710a, in case the MCG IAB node DU realizes link blockage, the MCG IAB node DU may transmit the “Link Blockage” notification message to the IAB donor CU over the F1-U interface, as part of the Downlink Data Delivery Status (DDDS) PDU (or the DDDS frame) of the concerned data radio bearer.

In step 1710b-1, in case the dual-connecting IAB node MT realizes link blockage, the dual-connecting IAB node MT may trigger the RACH procedure to the SCG IAB node DU.

In step 1710b-2, after performing the RACH procedure, the SCG IAB node DU may perceive link blockage and send the UE Link Blockage Indication, new message, or existing message to the IAB donor CU in order to request or trigger route change toward already established redundant route.

In step 1711, upon receiving of DDDS PDU (or the DDDS frame) from the MCG IAB node DU or the message from the SCG IAB node DU, the IAB donor CU may determine route change toward already established redundant route. In addition, when load balancing over both routes is needed, the IAB donor CU may decide to use already established redundant route.

Step 1712, the IAB donor CU may send to the SCG IAB node DU the UE Context Modification Request or new message including a Resource Allocation Indication to request allocating radio resource to the established bearer(s) in Step 1701. If the IAB donor CU received the UE Requested Bearer Status in step 1707, the IAB donor CU may transmit to the SCG IAB node DU the UE Context Modification Request or new message including the list of established bearer(s) to which the SCG IAB node DU can allocate the radio resource without a Resource Allocation Indication.

In step 1713, on receiving the message, the SCG IAB node DU may decide whether to be able to allocate the radio resource to requested bearer(s). When the SCG IAB node DU receives the message with the indication, the SCG IAB node DU may allocate the radio resource to requested bearer(s). The SCG IAB node DU may send the UE Context Modification Response or new message to the IAB donor CU.

According to some embodiments of the present disclosure, after adding redundant route, the SCG IAB node DU may not allocate the radio resource to established bearer(s) when the IAB donor CU realizes that the redundant route is not used. For example, the SCG IAB node DU may allocate the radio resource to established bearer(s) when link blockage between the dual-connecting IAB node MT and the MCG IAB node DU happens. For other example, the SCG IAB node DU may allocate the radio resource to established bearer(s) when or the load is balanced over both routes.

Therefore, it is possible for the SCG IAB node DU to use its radio resource efficiently during the redundant route is not used. In addition, experience of UE or the IAB node MT could be better (for example, seamless IAB node DU change).

According to some embodiments of the present disclosure, examples of methods for controlling radio resource of a redundant route for a dual-connecting IAB node in a wireless communication system described above with reference to FIGS. 14 to 17 may be applied to other technical field such as conditional Handover (HO) case. For example, in order to perform conditional handover, based on measurement report from the UE, source eNB/gNB may request the handover to candidate target eNBs/gNBs. In the conditional HO procedure, source eNB/gNB may send, to the target eNB/gNB, an indication. The indication may indicate whether the target eNB/gNB allocates the radio resource to the accepted or requested bearer(s) or not. If the target eNB/gNB is split as CU and DU, target eNB/gNB-CU may forward the indication to the target eNB/gNB-DU.

The present disclosure may be applied to various future technologies, such as AI, robots, autonomous-driving/self-driving vehicles, and/or extended reality (XR).

<AI>

AI refers to artificial intelligence and/or the field of studying methodology for making it. Machine learning is a field of studying methodologies that define and solve various problems dealt with in AI. Machine learning may be defined as an algorithm that enhances the performance of a task through a steady experience with any task.

An artificial neural network (ANN) is a model used in machine learning. It can mean a whole model of problem-solving ability, consisting of artificial neurons (nodes) that form a network of synapses. An ANN can be defined by a connection pattern between neurons in different layers, a learning process for updating model parameters, and/or an activation function for generating an output value. An ANN may include an input layer, an output layer, and optionally one or more hidden layers. Each layer may contain one or more neurons, and an ANN may include a synapse that links neurons to neurons. In an ANN, each neuron can output a summation of the activation function for input signals, weights, and deflections input through the synapse. Model parameters are parameters determined through learning, including deflection of neurons and/or weights of synaptic connections. The hyper-parameter means a parameter to be set in the machine learning algorithm before learning, and includes a learning rate, a repetition number, a mini batch size, an initialization function, etc. The objective of the ANN learning can be seen as determining the model parameters that minimize the loss function. The loss function can be used as an index to determine optimal model parameters in learning process of ANN.

Machine learning can be divided into supervised learning, unsupervised learning, and reinforcement learning, depending on the learning method. Supervised learning is a method of learning ANN with labels given to learning data. Labels are the answers (or result values) that ANN must infer when learning data is input to ANN. Unsupervised learning can mean a method of learning ANN without labels given to learning data. Reinforcement learning can mean a learning method in which an agent defined in an environment learns to select a behavior and/or sequence of actions that maximizes cumulative compensation in each state.

Machine learning, which is implemented as a deep neural network (DNN) that includes multiple hidden layers among ANN, is also called deep learning. Deep learning is part of machine learning. In the following, machine learning is used to mean deep learning.

<Robot>

A robot can mean a machine that automatically processes or operates a given task by its own abilities. In particular, a robot having a function of recognizing the environment and performing self-determination and operation can be referred to as an intelligent robot. Robots can be classified into industrial, medical, household, military, etc., depending on the purpose and field of use. The robot may include a driving unit including an actuator and/or a motor to perform various physical operations such as moving a robot joint. In addition, the movable robot may include a wheel, a break, a propeller, etc., in a driving unit, and can travel on the ground or fly in the air through the driving unit.

<Autonomous-Driving/Self-Driving>

The autonomous-driving refers to a technique of self-driving, and an autonomous vehicle refers to a vehicle that travels without a user's operation or with a minimum operation of a user. For example, autonomous-driving may include techniques for maintaining a lane while driving, techniques for automatically controlling speed such as adaptive cruise control, techniques for automatically traveling along a predetermined route, and techniques for traveling by setting a route automatically when a destination is set. The autonomous vehicle may include a vehicle having only an internal combustion engine, a hybrid vehicle having an internal combustion engine and an electric motor together, and an electric vehicle having only an electric motor, and may include not only an automobile but also a train, a motorcycle, etc. The autonomous vehicle can be regarded as a robot having an autonomous driving function.

<XR>

XR are collectively referred to as VR, AR, and MR. VR technology provides real-world objects and/or backgrounds only as computer graphic (CG) images, AR technology provides CG images that is virtually created on real object images, and MR technology is a computer graphics technology that mixes and combines virtual objects in the real world. MR technology is similar to AR technology in that it shows real and virtual objects together. However, in the AR technology, the virtual object is used as a complement to the real object, whereas in the MR technology, the virtual object and the real object are used in an equal manner. XR technology can be applied to HMD, head-up display (HUD), mobile phone, tablet PC, laptop, desktop, TV, digital signage. A device to which the XR technology is applied may be referred to as an XR device.

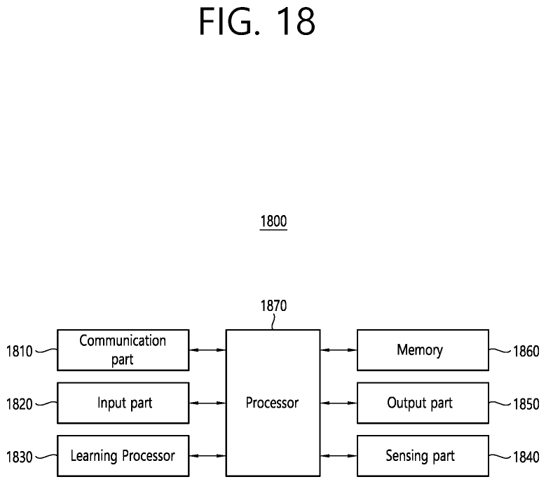

FIG. 18 shows an example of an AI device to which the technical features of the present disclosure can be applied.

The AI device 1800 may be implemented as a stationary device or a mobile device, such as a TV, a projector, a mobile phone, a smartphone, a desktop computer, a notebook, a digital broadcasting terminal, a PDA, a PMP, a navigation device, a tablet PC, a wearable device, a set-top box (STB), a digital multimedia broadcasting (DMB) receiver, a radio, a washing machine, a refrigerator, a digital signage, a robot, a vehicle, etc.

Referring to FIG. 18, the AI device 1800 may include a communication part 1810, an input part 1820, a learning processor 1830, a sensing part 1840, an output part 1850, a memory 1860, and a processor 1870.

The communication part 1810 can transmit and/or receive data to and/or from external devices such as the AI devices and the AI server using wire and/or wireless communication technology. For example, the communication part 1810 can transmit and/or receive sensor information, a user input, a learning model, and a control signal with external devices. The communication technology used by the communication part 1810 may include a global system for mobile communication (GSM), a code division multiple access (CDMA), an LTE/LTE-A, a 5G, a WLAN, a Wi-Fi, Bluetooth™, radio frequency identification (RFID), infrared data association (IrDA), ZigBee, and/or near field communication (NFC).

The input part 1820 can acquire various kinds of data. The input part 1820 may include a camera for inputting a video signal, a microphone for receiving an audio signal, and a user input part for receiving information from a user. A camera and/or a microphone may be treated as a sensor, and a signal obtained from a camera and/or a microphone may be referred to as sensing data and/or sensor information. The input part 1820 can acquire input data to be used when acquiring an output using learning data and a learning model for model learning. The input part 1820 may obtain raw input data, in which case the processor 1870 or the learning processor 1830 may extract input features by preprocessing the input data.

The learning processor 1830 may learn a model composed of an ANN using learning data. The learned ANN can be referred to as a learning model. The learning model can be used to infer result values for new input data rather than learning data, and the inferred values can be used as a basis for determining which actions to perform. The learning processor 1830 may perform AI processing together with the learning processor of the AI server. The learning processor 1830 may include a memory integrated and/or implemented in the AI device 1800. Alternatively, the learning processor 1830 may be implemented using the memory 1860, an external memory directly coupled to the AI device 1800, and/or a memory maintained in an external device.

The sensing part 1840 may acquire at least one of internal information of the AI device 1800, environment information of the AI device 1800, and/or the user information using various sensors. The sensors included in the sensing part 1840 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a light detection and ranging (LIDAR), and/or a radar.

The output part 1850 may generate an output related to visual, auditory, tactile, etc. The output part 1850 may include a display unit for outputting visual information, a speaker for outputting auditory information, and/or a haptic module for outputting tactile information.

The memory 1860 may store data that supports various functions of the AI device 1800. For example, the memory 1860 may store input data acquired by the input part 1820, learning data, a learning model, a learning history, etc.

The processor 1870 may determine at least one executable operation of the AI device 1800 based on information determined and/or generated using a data analysis algorithm and/or a machine learning algorithm. The processor 1870 may then control the components of the AI device 1800 to perform the determined operation. The processor 1870 may request, retrieve, receive, and/or utilize data in the learning processor 1830 and/or the memory 1860, and may control the components of the AI device 1800 to execute the predicted operation and/or the operation determined to be desirable among the at least one executable operation. The processor 1870 may generate a control signal for controlling the external device, and may transmit the generated control signal to the external device, when the external device needs to be linked to perform the determined operation. The processor 1870 may obtain the intention information for the user input and determine the user's requirements based on the obtained intention information. The processor 1870 may use at least one of a speech-to-text (STT) engine for converting speech input into a text string and/or a natural language processing (NLP) engine for acquiring intention information of a natural language, to obtain the intention information corresponding to the user input. At least one of the STT engine and/or the NLP engine may be configured as an ANN, at least a part of which is learned according to a machine learning algorithm. At least one of the STT engine and/or the NLP engine may be learned by the learning processor 1830 and/or learned by the learning processor of the AI server, and/or learned by their distributed processing. The processor 1870 may collect history information including the operation contents of the AI device 1800 and/or the user's feedback on the operation, etc. The processor 1870 may store the collected history information in the memory 1860 and/or the learning processor 1830, and/or transmit to an external device such as the AI server. The collected history information can be used to update the learning model. The processor 1870 may control at least some of the components of AI device 1800 to drive an application program stored in memory 1860. Furthermore, the processor 1870 may operate two or more of the components included in the AI device 1800 in combination with each other for driving the application program.

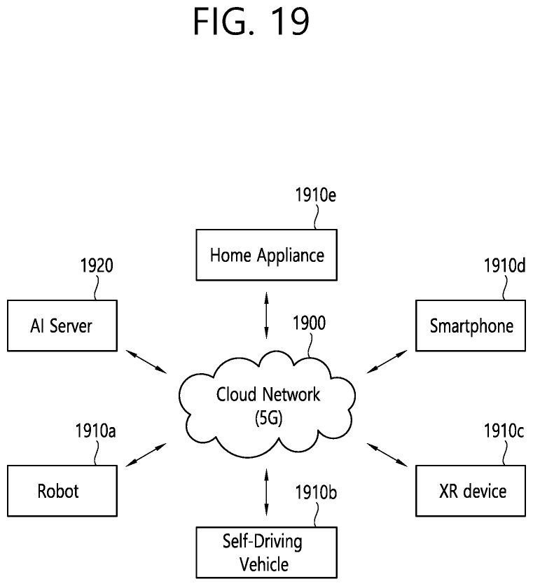

FIG. 19 shows an example of an AI system to which the technical features of the present disclosure can be applied.

Referring to FIG. 19, in the AI system, at least one of an AI server 1920, a robot 1910a, an autonomous vehicle 1910b, an XR device 1910c, a smartphone 1910d and/or a home appliance 1910e is connected to a cloud network 1900. The robot 1910a, the autonomous vehicle 1910b, the XR device 1910c, the smartphone 1910d, and/or the home appliance 1910e to which the AI technology is applied may be referred to as AI devices 1910a to 1910e.

The cloud network 1900 may refer to a network that forms part of a cloud computing infrastructure and/or resides in a cloud computing infrastructure. The cloud network 1900 may be configured using a 3G network, a 4G or LTE network, and/or a 5G network. That is, each of the devices 1910a to 1910e and 1920 consisting the AI system may be connected to each other through the cloud network 1900. In particular, each of the devices 1910a to 1910e and 1920 may communicate with each other through a base station, but may directly communicate with each other without using a base station.

The AI server 1920 may include a server for performing AI processing and a server for performing operations on big data. The AI server 1920 is connected to at least one or more of AI devices constituting the AI system, i.e. the robot 1910a, the autonomous vehicle 1910b, the XR device 1910c, the smartphone 1910d and/or the home appliance 1910e through the cloud network 1900, and may assist at least some AI processing of the connected AI devices 1910a to 1910e. The AI server 1920 can learn the ANN according to the machine learning algorithm on behalf of the AI devices 1910a to 1910e, and can directly store the learning models and/or transmit them to the AI devices 1910a to 1910e. The AI server 1920 may receive the input data from the AI devices 1910a to 1910e, infer the result value with respect to the received input data using the learning model, generate a response and/or a control command based on the inferred result value, and transmit the generated data to the AI devices 1910a to 1910e. Alternatively, the AI devices 1910a to 1910e may directly infer result value for the input data using a learning model, and generate a response and/or a control command based on the inferred result value.

Various embodiments of the AI devices 1910a to 1910e to which the technical features of the present disclosure can be applied will be described. The AI devices 1910a to 1910e shown in FIG. 19 can be seen as specific embodiments of the AI device 1800 shown in FIG. 18.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method performed by a central unit (CU) of an integrated access and backhaul (IAB)-donor in a wireless communication system, wherein the CU of the IAB-donor is connected with a dual-connecting IAB-node via a master cell group (MCG) IAB-node, the method comprising:
initiating an establishment of a connection with the dual-connecting IAB-node via a secondary cell group (SCG) IAB-node;
transmitting, to the SCG IAB-node, a first information which informs not allocating radio resource for a bearer;
determining to use the connection with the dual-connecting IAB-node via the SCG IAB-node; and
transmitting, to the SCG IAB-node, a second information to request allocating the radio resource for the bearer.

2. The method of claim 1, wherein the method further comprises,
performing a transmission to the dual-connecting IAB-node via the SCG IAB-node based on the radio resource for the bearer.

3. The method of claim 1, wherein the method further comprises,
receiving a third information that link blockage between the MCG IAB-node and the dual-connecting IAB-node occurs.

4. The method of claim 3, wherein the determination to use the connection with the dual-connecting IAB-node via the SCG IAB-node is based on the third information.

5. The method of claim 3, wherein the third information is transmitted from the MCG IAB-node as part of a Downlink Data Delivery Status frame.

6. The method of claim 3, wherein the third information is transmitted from the SCG IAB-node based on that the SCG IAB-node detects a random access of the dual-connecting IAB-node.

7. The method of claim 1, wherein the method further comprises,
receiving, from the SCG IAB-node, UE Requested Bearer Status which informs whether allocating the radio resource for the bearer is possible or not.

8. The method of claim 7, wherein the determination to use the connection with the dual-connecting IAB-node via the SCG IAB-node is based on the UE Requested Bearer Status.

9. The method of claim 1, wherein the determination to use the connection with the dual-connecting IAB-node via the SCG IAB-node is based on whether load balancing between the MCG IAB-node and the SCG IAB-node for the dual connected IAB-node is required.

10. The method of claim 1, wherein the second information is included in a UE Context Modification Request Message.

11. The method of claim 1, wherein the bearer is related to the connection with the dual-connecting IAB-node via the SCG IAB-node;

12. A method performed by a secondary cell group (SCG) integrated access and backhaul (IAB)-node in a wireless communication system, the method comprising:
receiving, a central unit (CU) of a IAB-donor, a first information which informs not allocating radio resource for a bearer, wherein the CU of the IAB donor is connected with a dual-connecting IAB-node via a master cell group (MCG) IAB-node;
receiving, from the CU of the IAB-donor, a second information to request allocating the radio resource for the bearer;
allocating the radio resource for the bearer; and
performing a communication with the dual-connecting IAB-node based on the radio resource for the bearer.

13. The method of claim 12, wherein the method further comprises,
establishing a connection with the dual-connecting IAB-node and the CU of the IAB-donor, wherein the bearer is related to the connection with the dual-connecting IAB-node and the CU of the IAB-donor via the SCG IAB-node.

14. The method of claim 12, wherein the method further comprises,
transmitting, to the CU of the IAB-donor, UE Requested Bearer Status which informs whether allocating the radio resource for the bearer is possible or not.

15. The method of claim 12, wherein the method further comprises,
determining that link blockage between the MCG IAB-node and the dual-connecting IAB-node occurs; and
transmitting, to the CU of the IAB-donor, a third information which informs that the link blockage occurs.

16. The method of claim 15, wherein the determination that the link blockage occurs is based on that random access procedure is triggered by the dual-connecting IAB-node.
